(19) United States
(12) Patent Application Publication
(10) Pub. No.: US 2023/0331402 A1
(43) Pub. Date: Oct. 19, 2023

(54) A UNIT FOR CAUSING ANGULAR MOMENTUM ABOUT AN AXIS

(71) Applicant: NEWSPACE SYSTEMS (PTY) LTD, Somerset West (ZA)

(72) Inventors: Antony James BARRINGTON-BROWN, Somerset West (ZA); Rudolf Wilhelm GLATTHAAR, Somerset West (ZA); Riddhi Anubhav MAHARAJ, Somerset West (ZA)

(21) Appl. No.: 17/905,695

(22) PCT Filed: Mar. 5, 2021
(86) PCT No.: PCT/ZA2021/050013

§ 371 Date: Sep. 6, 2022

(30) Foreign Application Priority Data
Mar. 6, 2020 (ZA) 2020/01453

(51) Int. Cl. B64G 1/28; B64G 1/24; B64G 1/40; B64G 1/36

(52) U.S. Cl. CPC B64G 1/28; B64G 1/244; B64G 1/402; B64G 1/36

(57) ABSTRACT

A unit (10) for causing angular momentum (11) about an axis (13a), which unit includes, inflow sequence, an incoming fluid pathway (12), a first fluid pathway (14a) in fluid communication with the incoming fluid pathway (12), a second fluid pathway (16a) in fluid communication with the incoming fluid pathway (12), an outgoing fluid pathway (18) in fluid communication with the first and second fluid pathway (14a, 16a), a flow regulating means (20a) for regulating the proportional flow in the first and second fluid pathways (14a, 16a), and wherein the first and second fluid pathways (14a, 16a) are respectively arranged about the axis (13a) generally in a plane transverse to the axis (13a).

### TECHNICAL FIELD

This invention relates to a unit for causing angular momentum about an axis. In particular, this invention relates to a unit for causing angular momentum about an axis by displacing a fluid.

### SUMMARY OF THE INVENTION

According to the invention, there is provided a unit for causing angular momentum about an axis, which unit includes, in flow sequence:
an incoming fluid pathway;
a first fluid pathway in fluid communication with the incoming fluid pathway;
a second fluid pathway in fluid communication with the incoming fluid pathway;
an outgoing fluid pathway in fluid communication with the first and second fluid pathway;
a flow regulating means for regulating the proportional flow in the first and second fluid pathways; and
wherein the first and second fluid pathways are respectively arranged about the axis generally in a plane transverse to the axis.

The first and second fluid pathways may also be spaced from each other along the axis. In this case the planes are spaced but parallel. Spacing of the planes allows for the even distribution of the mass of the unit in an object such as a satellite. It is to be appreciated that the first and/or second fluid pathways may be arranged in separate planes transverse or perpendicular to the axis and which are spaced from each other.

In some embodiments two units may be spaced opposite each other along the axis with its respective fluid flow arranged to be in opposite directions. Such opposed units can then function as a single unit with the effect being the sum of the angular momentum caused in the opposed units. In this case the planes are also spaced but parallel.

In some embodiments two units may also be respectively arranged along spaced parallel axes. Such spaced units can then function as a single unit with the effect being the sum of the angular momentum caused in the opposed units about an imaginary combined axis.

It is to be understood that the angular momentum vector is always in line with the axis perpendicular to the plane in which the unit is, and the unit will normally be centred about the axis. The principle for generating an angular momentum vector that is directed along the axis perpendicular to the plane, is that the routing of the two fluid pathways are opposite, causing fluid to flow in a clockwise direction in the one pathway, and in a counter clockwise direction in the other pathway. Two momentum vectors are generated along the axis perpendicular to the plane, with their directions opposite to each other. The vector sum of the two momentum vectors gives a resultant momentum vector of finite magnitude greater or equal to zero, with a direction in the defined positive or negative direction of the plane perpendicular axis.

The first and second fluid pathways may be arranged to form any suitable geometric shape in the plane perpendicular to the axis which may be selected from the group including a circle, oval, rectangle, parallelogram, square, rhombus, hexagon, octagon, nonagon and decagon, preferably being a circle. It may be appreciated that the shape in which the first and second fluid pathways are arranged may depend on a cross-sectional shape of an object, preferably a satellite, to which the pathways may be attached or form part of. It may be appreciated that the further the first and second fluid pathways are spaced from the axis the greater the angular momentum caused about the axis will be. It may be appreciated that the first and/or second fluid pathways may form a loop about the axis, respectively. It is to be appreciated that the first and/or second fluid pathways which form the respective loops may be arranged in separate planes transverse or perpendicular to the axis and which are spaced from each other. It is to be appreciated that a centre of a mass of that specific loop forms the axis. It is to be appreciated that the loop formed by the first and/or second fluid pathways may share a common axis or each have their own axes respectively. Preferably, the loop may be in the form of a helical loop. The pathways may be in the form of closed pathways, passages, ducts, tubing, piping, extrusions, preferably being tubing. The tubing may be manufactured from any suitable material, preferably a material with a high thermal conductivity, which may include any one or more of the group consisting of aluminium, inconel, copper, titanium, high thermally conductive plastic tubing or space-approved soft pneumatic tubing. Passages may be machined into the body, frame or chassis of an object such as a satellite.

The flow regulating means may be in the form of a 1 to 2 proportional valve in fluid flow communication with the incoming fluid pathway or two 1 to 1 proportional valves one in the first fluid pathway and one is the second fluid pathway and which may be configured to regulate proportional flow in the first and second fluid pathways. It may be understood that the sum of the flow in the first fluid pathway and the second fluid pathway is to be equal to the flow in the incoming fluid pathway and equal to the flow in the outgoing fluid pathway. It may be appreciated that the flow in incoming fluid pathway is equal to the flow in the outgoing fluid pathway. It may be appreciated that the valves may be in the form of any one or more of the group including solenoid valves, coaxial valves, motor valves or the like. Alternatively, the flow regulating means may be in the form of a magnetohydrodynamic pump for regulating the proportional flow of a fluid, preferably a conductive fluid, in the first and second fluid pathways. Preferably, the conductive fluid is a liquid metal. The liquid metal may be selected from the group including mercury, indium, ceasium, rubidium, francium, gallium and any eutectic or liquid metal alloys such as the alloy known by the trade name Galinstan, preferably being Galinstan. It may be understood that the regulating means in the form of a magnetohydrodynamic pump regulates the flow in the first and second fluid pathways by generating a force along the first and second pathway in the direction or opposite to the flow of the fluid, to accelerate, decelerate and/or divert the flow as the case may be. It is to be appreciated that the flow regulating means may be in the form of any suitable flow regulating means for regulating the flow of the conductive fluid and may be in the form of magnets for inducing eddy currents in the fluid and/or a combination of magnets and an energising means, preferably in the form of a battery, to exert a Lorenz force on the fluid.

A displacement means may be provided for displacing the fluid, along the fluid pathways. The displacement means may be in the form of any suitable conventional pump, preferably being a magnetohydrodynamic pump. The magnetohydrodynamic pump may be in the form of any suitable conventional magnetohydrodynamic pump. It may be appreciated that a rate at which the displacement means displaces the fluid along the fluid path is directly proportional the angular momentum caused about the axis.

It is to be appreciated that one or more units for causing angular momentum about an axis can be arranged in or on an object, such as a satellite, with the respective axes transverse, preferably perpendicular, to each other to maintain or change the attitude of an object.

It is further to be appreciated that one or more units may be in fluid communication to one displacement means, preferably in the form of a pump, to displace the fluid along the pathways of each unit to generate an angular moment and/or torque about the respective axis of each unit. It is therefore to be appreciated that one pump may be used to cause flow through a number of units to maintain or change the attitude of an object. Attitude is controlled though control of the proportional flow regulating means such as proportional valves.

A mounting means may further be provided for mounting the pathways on the object. The mounting means may be configured to mount the pathways on the exterior or interior of the object, such as a satellite, more specifically a satellite frame, for allowing the fluid that is displaced in the pathways to cause angular momentum about an axis of the object to correct a disturbance in a desired attitude of the object. Alternatively, members of the satellite frame may form the pathways. It is to be appreciated that these members may be 3D printed, machined or moulded to allow the pathways to form part of the satellite frame. It is to be appreciated that one of the main advantages of the invention is that the fluid pathways can be shaped and configured in numerous configurations to make use of available space and to flow on the interior or exterior of an object, such as a satellite. The mounting means may be in the form of any suitable mounting means which does not disrupt the flow of the fluid along the pathways which may be selected from the group including brackets, mounting interfaces, bolts and nuts, hooks, epoxy glue or the like.

A stability fluid pathway, which has the function of a flywheel which provides gyroscopic stability may be arranged in fluid communication with the incoming fluid pathway and/or the first fluid pathway and/or the second fluid pathway and/or the outgoing fluid pathway for stabilizing the object in a plane. The stability fluid pathway may be arranged to form any suitable geometric shape. It may be appreciated that the shape in which the stability fluid pathway is arranged may depend on the cross-sectional shape of the object to which the pathway may be attached, but is not restricted thereby. It is to be appreciated that the shape in which the stability pathway is arranged will depend on size and/or shape requirements of the object to which the pathway is to be attached. Preferably, the stability fluid pathway may be in the form of tubing having any cross-sectional shape. The tubing may be manufactured from any suitable material, preferably a material with a high thermal conductivity, which may include any one or more of the group consisting of aluminium, inconel, copper, titanium, high thermally conductive plastic tubing or space-approved soft pneumatic tubing. It may be appreciated that more than one stability fluid pathway can be stacked on top of one another to increase the stability in a plane because an increase in the number of stability fluid pathways causes an increase in mass in that plane which is directly proportional to an increase in stability. It is to be appreciated that the function of a stability fluid pathway is similar to that of a gyroscope flywheel. It is to be appreciated that the first and/or second fluid pathways in the form of a helical loop may also act as a stability fluid pathway for stabilizing the object in the plane in which it is arranged. Alternatively, first and/or second fluid pathways are arranged in different planes and a plane of gyroscopic stability is a combination of the different planes of the first and/or second fluid pathways which is dependant on the relative flow of fluid in each of the pathways.

A sensor may be provided for sensing the disturbance in the desired attitude of the object. The sensor may be in the form of any suitable conventional sensor which may include any one or more of the group consisting of an accelerometer, gyroscope, sun sensor, magnetometer, inertial motion unit (IMU), star tracker, stellar gyro, RAM sensor, earth sensor and the like. Alternatively, the sensor may be in the form of an attitude detection sensor for detecting a current attitude of an object to determine if there has been a disturbance in a desired attitude of the object. Further alternatively, the sensor may be in the form of a fluid displacement rate sensor for sensing the rate of fluid displacement in the pathways which may be utilized to determine a current attitude of an object to further determine if there has been a disturbance in a desired attitude of the object.

A control system may be arranged in communication with the sensor and flow regulating means to allow the attitude of the object to be corrected in response to the disturbance sensed by the sensor. The control system may be configured to control the flow regulating means for regulating an amount of flow of the fluid in the first and second fluid pathways to cause a desired moment and/or torque to maintain or change the attitude. The control system may be in the form of a processor for processing a signal received from the sensor and generating an output signal in response thereto and sending the output signal to the flow regulating means to regulate the amount of flow of the fluid in the first and second pathways. The processor may be in the form of any suitable conventional processor. It may be appreciated that if the fluid in the stability fluid pathway is displaced using the magnetohydrodynamic pump the disturbance in the desired attitude of the object will result in a detectible feedback signal which may be processed by the processor allowing the output signal to be generated in response thereto and sending the output signal to the flow regulating means to regulate the amount of flow of the fluid in the first and second pathways. The control system may also be arranged in communication with the displacement means for controlling the displacement of the fluid along the fluid pathways.

A propulsion system may be arranged in fluid communication with the unit as described above for allowing the fluid in the pathways of the unit to be used as a propellant by the propulsion system to propel the object, thus the unit acts as a storage means for storing the propellant which is used by the propulsion system. The propulsion system may include a thruster arrangement, which may include at least one thruster system, and a regulating means arrangement, which may include at least one valve, wherein the regulating means arrangement is in fluid flow communication with the thruster arrangement and the pathways. The thruster system and the valve may be in the form of any suitable conventional thruster system and valve, respectively. Preferably, the thruster system may be in the form of a FEEP (Field Emission Electric Propulsion) thruster, a liquid metal electrospray thruster or a liquid-fed PPT (Pulsed Plasma Thruster) thruster. The regulating means may be arranged in communication with the control system to control the regulating means between an open condition wherein fluid is allowed to flow from the pathways to the thruster arrangement, and a closed condition where no fluid flows from the pathways to the thruster arrangement. It may be appreciated that the propulsion system allows an orbit of the satellite to be changed when the satellite is no longer being used at the end of its life.

It may be appreciated that more than one unit as described above may be stacked on top of one another in a plane to allow an increase in mass in that plane which is directly proportional to an increase in the angular momentum caused about the axis. It is to be appreciated that an increase in a number of windings of the helical loop in a plane also allows an increase in mass in that plane which is directly proportional to an increase in the angular momentum caused about the axis.

The invention also relates to an attitude control system of an object, such as a satellite, which includes two or more units as described above. Each unit is placed in any two or more of an X-axis, Y-axis and Z-axis of the object for allowing angular momentum to be caused about each of these axes to correct the attitude of the object in two or three dimensions. It is to be appreciated that the attitude control system will use a single displacement means system, preferably in the form of a single pump system, which includes at least one displacement means as hereinbefore described, to control the displacement of the fluid along the pathways of each unit about each respective axis, thus allowing the attitude of the object to be corrected in more than one dimension by only using a single displacement means system. It is to be appreciated that the single displacement means system may include a plurality of displacement means as hereinbefore described. Typical control parameters include fluid density, fluid flow, distance of the fluid pathway from the centre of mass of the object, mass of the object and the like.

According to another aspect of the invention there is provided a temperature regulating means configured from the unit as described above to control the temperature of the object by routing the fluid pathways such that fluid is displaced from a hot region of the object to a cool region of the object or vice versa to allow heat to be redistributed through the use of forced convection.

It may be appreciated that impulse torque can also be generated by a change in the angular momentum τ=dL/dt where τ=torque and L=momentum.

### BRIEF DESCRIPTION OF THE DRAWINGS

A unit for causing angular momentum about an axis in accordance with the invention will now be described by way of the following, non-limiting examples with reference to the accompanying drawings.

In the drawings: —

FIG. 1 is a schematic showing the unit in the X-axis and Y-axis with a stability fluid pathway arranged in the Z-axis;

FIG. 2a is a schematic showing first and second fluid pathways in the form of loops spaced far apart;

FIG. 2b is a schematic showing first and second fluid pathways in the form of loops sharing a common axis;

FIG. 2c is a schematic showing first and second fluid pathways in the form of loops for 3 axes of an object;

FIG. 3 is a schematic showing an attitude control system with sensors and a control system;

FIG. 4 is a schematic showing the unit in fluid communication with the propulsion system;

FIG. 5 is a schematic illustrating the concept of using the unit to control temperature of a satellite;

FIG. 6 is a table illustrating examples of specific configurations of the unit;

FIG. 7a is a schematic showing a stability fluid pathway arranged in fluid communication with a first and second pathway; and

FIG. 7b is a schematic showing the stability fluid pathway as shown in FIG. 7a wherein the gyroscopic stability axis is tilted.

### DETAILED DESCRIPTION OF THE INVENTION

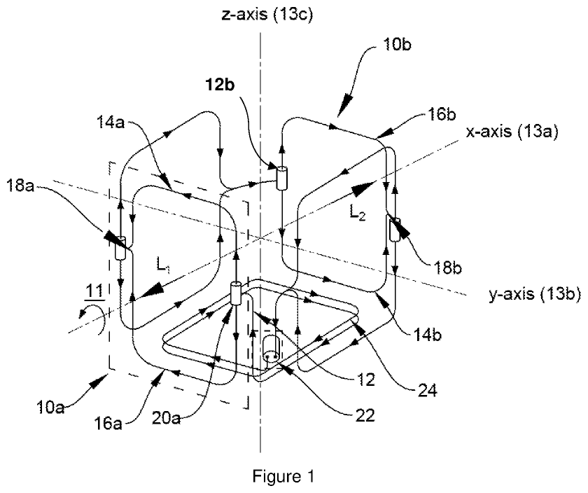

Referring now to FIG. 1 of the drawings, reference numeral 10a refers generally to a unit for causing angular momentum 11 about an axis. In this example axis 13a will be used as the reference axis. The unit 10 includes, in flow sequence, an incoming fluid pathway 12, a first fluid pathway 14a in fluid communication with the incoming fluid pathway 12, a second fluid pathway 16a in fluid communication with the incoming fluid pathway 12, an outgoing fluid pathway 18 in fluid communication with the first and second fluid pathway 14a,16a, a flow regulating means 20a for regulating the proportional flow in the first and second fluid pathways 14a,16a, and wherein the first and second fluid pathways 14a,16a are respectively spaced about the axis 13a and generally arranged in a plane perpendicular to the axis 13a.

A further unit 10b along the same axis 13a is spaced opposite unit 10a and in a plane parallel to the plane of unit 10a. This units first and second fluid pathways are 14b and 16b. The fluid pathways 14a and 14b causes an angular momentum vector indicated by L1 and fluid pathways 16a and 16b causes an angular momentum vector indicated by L2. 14a and 14b is to be seen as a loop in one direction about the axis 13a and 16a and 16b is to be seen as a loop in the opposite direction about the axis 13a.

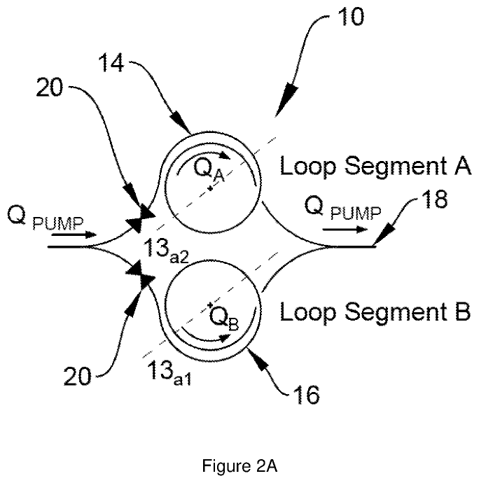

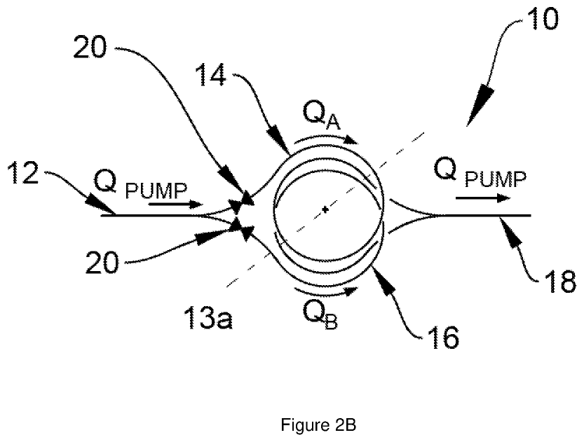

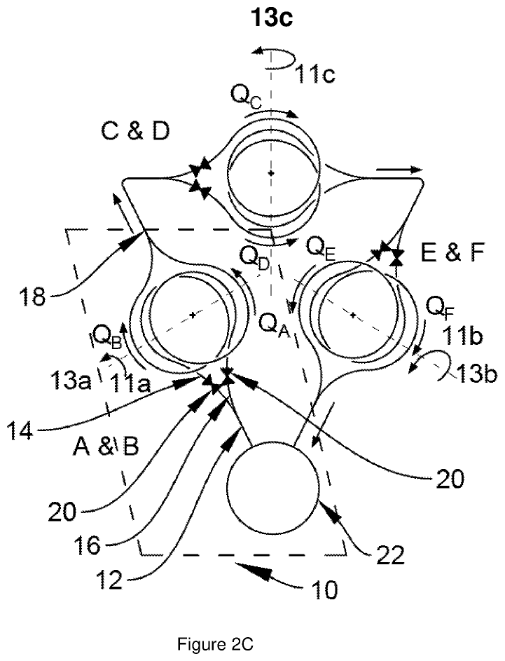

The first 14a,14b and second 16a,16b fluid pathways can be arranged to form any suitable geometric shape in the plane perpendicular to the axis 13a which is selected from, a square in this example. It is to be appreciated that the shape in which the first 14a,14b and second 16a,16b fluid pathways are arranged depends on a cross-sectional shape of an object, typically a satellite (not shown), to which the pathways 14a,14b,16a,16b are attached or form part of. It is to be appreciated that the further the first 14a,14b and second 16a,16b fluid pathways are spaced from the axis 13a the greater the angular momentum 11 caused about the axis 13a will be. It is to be appreciated that the first 14a,14b and second 16a,16b fluid pathways form a loop 14,16 about the axis 13a, respectively as shown in FIG. 2b. As shown in FIG. 1, it is to be appreciated that the first 14a,14b and second 16a,16b fluid pathways which form the respective loops 14,16 are arranged in separate planes (not shown) perpendicular to the axis 13a and which are spaced from each other. It is to be appreciated that a centre of a mass of that specific loop 14a,14b forms the axis 13a. As shown in FIG. 2A, it is to be appreciated that the loop 14,16 formed by the first 14a,14b and second 16a,16b fluid pathways share a common axis 13a or, as shown in FIG. 2A, each have their own axes 13a2,13a1 respectively. Typically, the pathways 14a,14b,16a,16b are in the form of tubing. The tubing 14a,14b,16a,16b is manufactured from any suitable material, typically a material with a high thermal conductivity, which includes any one or more of the group consisting of aluminium, Inconel, copper, titanium, high thermally conductive plastic tubing or space-approved soft pneumatic tubing.

The flow regulating means is in the form of a 1 to 2 proportional valve 20a, as shown in FIG. 1, in fluid flow communication with the incoming fluid pathway 12 which is configured to regulate proportional flow in the first 14a,16a and a second proportional valve 20b to regulate the flow second 14b,16b fluid pathways. It is to be understood that the sum of the flow in fluid pathways 14a,16a and the flow in fluid pathways 14b,16b is to be equal to the flow in the incoming fluid pathway 12 and equal to the flow in the outgoing fluid pathway 18. It is to be appreciated that the flow in incoming fluid pathway 12 is equal to the flow in the outgoing fluid pathway 18. It is to be appreciated that the valves 20 is in the form of solenoid valves. Alternatively, the flow regulating means is in the form of a magnetohydrodynamic pump 20 for regulating the proportional flow of a fluid, typically a conductive fluid (not shown). Typically, the conductive fluid is a liquid metal (not shown). The liquid metal is the eutectic alloy known as Galinstan. It is to be understood that the magnetohydrodynamic pump 20, as illustrated in FIG. 1, regulates the flow by diverting the flow of the fluid (not shown).

A displacement means 22 is provided for displacing the fluid, along the fluid pathways 12,14a,14b,16a,16b,18. The displacement means is in the form of any suitable conventional pump 22, typically being a magnetohydrodynamic pump in this example. The magnetohydrodynamic pump 22 is in the form of any suitable conventional magnetohydrodynamic pump. It is to be appreciated that a rate at which the pump 22 displaces the fluid (not shown) along the fluid path is directly proportional the angular momentum 11 caused about the axis 13a.

As shown in the example in FIG. 2c it is to be appreciated that one or more units 10 for causing angular momentum about an axis 13a,13b,13c can be arranged in or on a satellite (not shown), with the respective axes 13a,13b,13c at an angle, typically perpendicular, to each other to maintain or change the attitude of the satellite (not shown). It is further to be appreciated that the one or more units 10 use only one pump 22 to displace the fluid (not shown) along the pathways 14,16 of each unit 10 to generate an angular moment 11a,11b,11c and/or torque (not shown) about the respective axis 13a,13b,13c of each unit 10. It is therefore to be appreciated that one pump 22 is used to maintain or change the attitude of the satellite (not shown).

A mounting means (not shown) is further provided for mounting the pathways 12,14a,14b,16a,16b,18 on the satellite (not shown). The mounting means is configured to mount the pathways 12,14a,14b,16a,16b,18 on the exterior or interior of the satellite, more specifically a satellite frame, for allowing the fluid (not shown) that is displaced in the pathways 12,14a,14b,16a,16b,18 to cause angular momentum 11 about an axis 13 of the satellite (not shown) to correct a disturbance in a desired attitude of the satellite (not shown). Alternatively, members of the satellite frame (not shown) form the pathways. It is to be appreciated that these members (not shown) are 3D printed or moulded or machined to allow the pathways 12,14a,14b,16a,16b,18 to form part of the satellite frame (not shown). The mounting means (not shown) is in the form of any suitable mounting means which does not disrupt the flow of the fluid along the pathways which is selected from the group including brackets, mounting interfaces, bolts and nuts, hooks, epoxy glue or the like.

As shown in the example in FIG. 1, a stability fluid pathway 24 is arranged in fluid communication with the incoming fluid pathway 12 for gyroscopic stabilisation of the satellite (not shown) in a plane. The stability fluid pathway 24 is arranged in the shape of a square in this example. It is to be appreciated that the shape in which the stability fluid pathway 24 is arranged can depend on the cross-sectional shape of the satellite (not shown) to which the pathway 24 is attached, but is not restricted thereby. Typically, the stability fluid pathway is in the form of tubing 24 having any cross-sectional shape. The tubing 24 is manufactured from any suitable material, typically a material with a high thermal conductivity, which includes any one or more of the group consisting of aluminium, inconel, copper, titanium, high thermally conductive plastic tubing or space-approved soft pneumatic tubing. Alternatively, members of the satellite frame (not shown) form the stability fluid pathway 24. It is to be appreciated that these members (not shown) are 3D printed or moulded or machined to allow the stability fluid pathway 24 to form part of the satellite frame (not shown). It is to be appreciated that more than one stability fluid pathway 24 can be stacked on top of one another to increase the stability in a plane because an increase in the number of stability fluid pathways 24 causes an increase in mass in that plane which is directly proportional to an increase in stability.

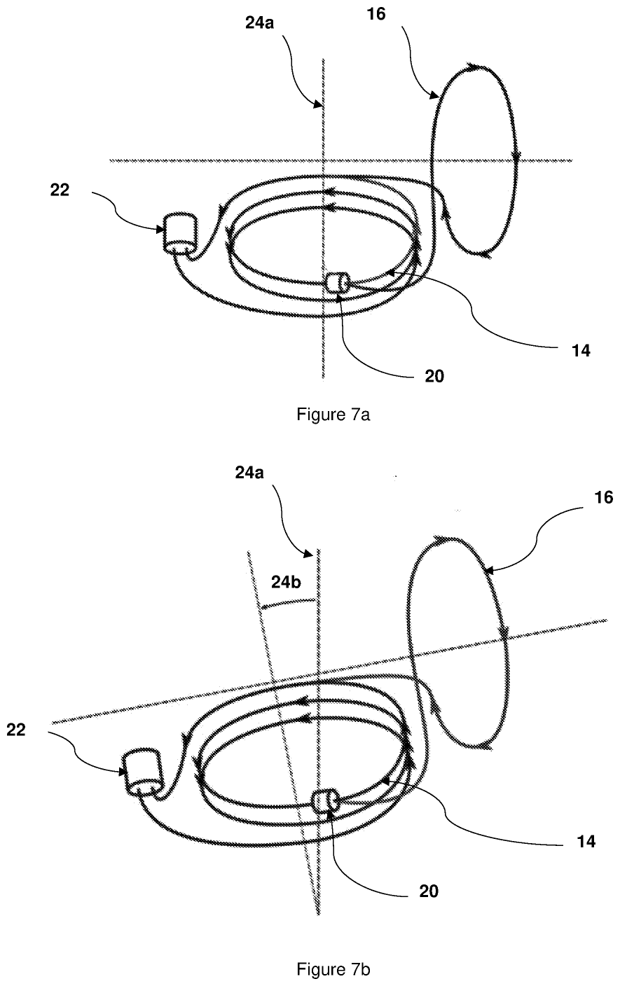

Alternatively, as shown in FIG. 7, the first and second fluid pathways 14, 16 are arranged in different planes and a plane of gyroscopic stability (not shown) is a combination of the different planes of the first and second fluid pathways 14, 16 which is dependant on the relative flow of fluid in each of the pathways 14, 16. By diverting fluid from the first 14 to second fluid 16 pathway, the gyroscopic stability axis 24a, and thereby the momentum vector (not shown), is tilted or realigned. The flow ratio between the two diverting fluid pathways 14, 16 determines the extent to which the gyroscopic axis 24a is tilted, such as for example, by diverting more fluid through the second fluid pathway increases the tilt angle 24b.

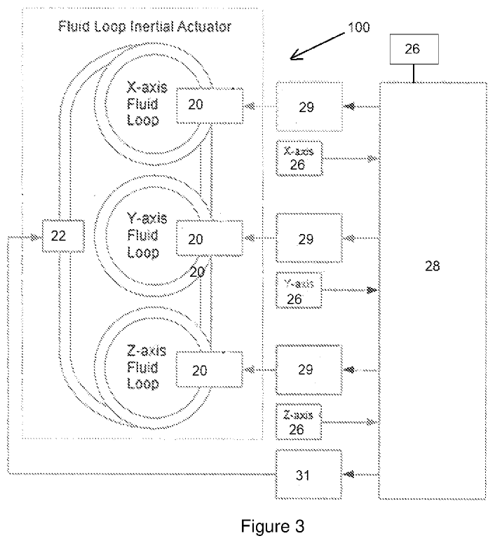

As shown in FIG. 3, a sensor 26 is provided for sensing the disturbance in the desired attitude of the satellite (not shown). The sensor 26 is in the form of any suitable conventional sensor which includes any one or more of the group consisting of an accelerometer, gyroscope, sun sensor, magnetometer, inertial motion unit (IMU), star tracker, stellar gyro, RAM sensors, earth sensor and the like. Alternatively, the sensor 26 is in the form of an attitude detection sensor for detecting a current attitude of a satellite (not shown) to determine if there has been a disturbance in a desired attitude of the satellite (not shown). Further alternatively, the sensor 26 is in the form of a fluid displacement rate sensor for sensing the rate of fluid displacement in the pathways 12,14a,14b,16a,16b,18 which is utilized to determine a current attitude of a satellite (not shown) to further determine if there has been a disturbance in a desired attitude of the satellite (not shown).

As shown in FIG. 3, a control system 28 is arranged in communication with the sensor 26 and 1 to 2 proportional valve 20 to allow the attitude of the satellite (not shown) to be corrected in response to the disturbance sensed by the sensor 26. The control system 28 is configured to control, typically via a valve driver 29, the 1 to 2 proportional valve 20a for regulating an amount of flow of the fluid pathways 14a and 16a and proportional valve 20b for regulating an amount of flow of the fluid in 14b and 16b to cause a desired moment 11 and/or torque (not shown). The control system is in the form of a processor 28 for processing a signal received from the sensor 26 and generating an output signal in response thereto and sending the output signal to the 1 to 2 proportional valve 20 to regulate the amount of flow of the fluid in the respective fluid pathways first. The processor 28 is in the form of any suitable conventional processor. It is to be appreciated that if the fluid (not shown) in the stability fluid pathway 24 is displaced using the magnetohydrodynamic pump 22 the disturbance in the desired attitude of the satellite (not shown) will result in a detectible feedback signal which is processed by the processor 28 allowing the output signal to be generated in response thereto and sending the output signal to the 1 to 2 proportional valve 20 to regulate the amount of flow in the fluid pathways. The control system 28 is also arranged in communication with the pump 22, via a pump driver 31, for controlling the displacement of the fluid (not shown) along the fluid pathways 12,14a,14b,16a,16b,18.

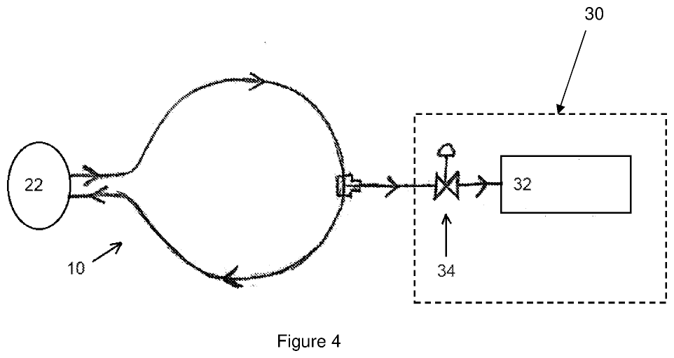

As shown in FIG. 4, a propulsion system 30 is arranged in fluid communication with the unit 10 as described above for allowing the fluid (not shown) in the pathways 12,14a,14b,16a,16b,18 of the unit 10 to be used as a propellant by the propulsion system 30 to propel the satellite (not shown), at the end of its life, thus the unit 10 acts as a storage means for storing the propellant which is used by the propulsion system 30. The propulsion system 30 includes a thruster arrangement 32, which includes at least on thruster system (not shown), and a regulating means arrangement 34, which includes at least one valve (not shown), wherein the regulating means arrangement 34 is in fluid flow communication with the thruster arrangement 32 and the pathways 12,14a, 14b,16a,16b,18. The thruster system (not shown) and the valve (not shown) are in the form of any suitable conventional thruster and valve, respectively. Typically, the thruster system (not shown) is in the form of a FEEP thruster, a liquid metal electrospray thruster or a liquid-fed PPT thruster. The a regulating means arrangement 34 is arranged in communication with the control system 28 to control the a regulating means arrangement 34 between an open condition wherein fluid (not shown) is allowed to flow from the pathways 12,14a,14b,16a,16b,18 to the thruster arrangement 32, and a closed condition where no fluid (not shown) flows from the pathways 12,14a,14b,16a,16b,18 to the thruster arrangement 32. It is to be appreciated that the propulsion system 30 allows an orbit the satellite (not shown) to be changed when the satellite (not shown) is no longer being used at the end of its life.

It is to be appreciated that more than one unit 10 as described above is stacked on top of one another in a plane to allow an increase in mass in that plane which is directly proportional to an increase in the angular momentum 11 caused about the axis 13a. It is to be appreciated that an increase in a number of windings (not shown) of the helical loop (not shown) in a plane also allows an increase in mass in that plane which is directly proportional to an increase in the angular momentum 11 caused about the axis 13a.

The invention also relates to an attitude control system 100 of a satellite (not shown), which includes two or more units 10 as described above. Each 10 unit is placed in any two or more of an X-axis 13aa, Y-axis 13ab and Z-axis 13ac of the satellite (not shown) for allowing angular momentum 11 to be caused about each of these axes 13a to correct the attitude of the satellite (not shown) in two or three dimensions.

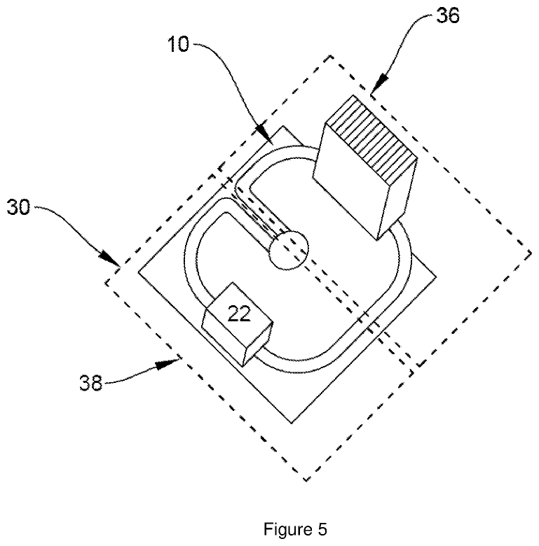

As shown in FIG. 5, it is to be appreciated that the unit 10 as described above is used to control the temperature of the satellite (not shown) as the displacement of fluid (not shown) from a hot region 36 of the satellite (not shown) to a cool region 38 of the satellite (not shown) allows heat to be redistributed through the use of forced convection.

It is to be appreciated that impulse torque can also be generated by a change in the angular momentum τ=dL/dt where τ=torque and L=momentum.

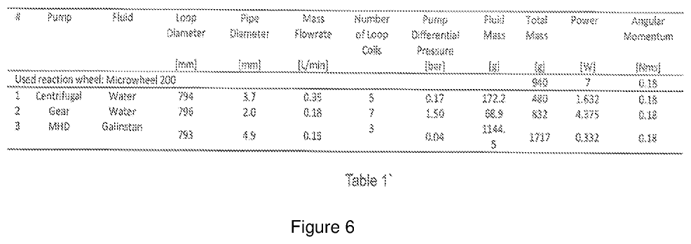

Referring now to FIG. 6 (Table 1), the invention will now be described by way of three specific examples wherein factors of type of pump, type of fluid, loop diameter, pipe diameter, mass flowrate, number of loop coils, pump differential pressure and fluid mass were varied for a SkySat-1 satellite with a mass of 83 kg and physical dimensions of 600 mm×600 mm×800 mm to stabilize the satellite. As a control, the satellite was stabilized using a Microwheel 200 reaction wheel.

The first configuration shown in Table 1 has the lowest overall mass which is close to half the mass of the control. The configuration also has a power consumption that is almost four times lower than the control but generates the same amount of angular momentum as the control, thus proving the viability of the use of the unit to control the attitude of the satellite.

The second configuration has the lowest fluid mass and uses a gear pump. The gear pump's higher pressure allows the liquid to be displaced through a much narrower channel, which reduces the fluid mass that is needed significantly. However, in this configuration the higher pump mass and the increase in the number of coils have a negative effect on the total mass of the unit.

The first two configurations are based on COTS (Commercial Off The Shelf) pumps that are not meant for use in space and are used only to illustrate the viability of the unit. The third configuration, however, is that it is based on an existing, space-qualified MHD pump. This pump has no moving parts, which makes it a reliable and long lifetime pump. Hence illustrating that it is possible to realize the use of the unit in space to control the attitude of a satellite. However, reverse calculations show that this pump does not provide a very high-pressure differential hence, the pipe diameter is larger than those of the other configuration resulting in an increase in fluid mass. The low-pressure differential puts a limit on the hydraulic power that the pump can produce and therefore its electric power consumption is the lowest at 0.332 W. This allows the pressure of the pump to be increased by increasing the voltage and current, without exceeding the overall power of the control system. This means that the total mass can be optimized further by producing higher pressures at higher voltages.

It is, of course, to be appreciated that the unit 10 for causing angular momentum 11 about an axis 13a in accordance with the invention is not limited to the precise constructional and functional details as hereinbefore described with reference to the accompanying drawings and which may be varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

The inventor believes that the unit 10 for causing angular momentum 11 about an axis 13a in accordance with the present invention is advantageous in that the unit 10 is customizable to suit the specific shape of a satellite (not shown) on which the unit 10 is mounted, thus allowing a lot less space to be wasted in the interior of the satellite (not shown) by a bulky attitude control system. Further, the unit 10 is advantageous in that it can be used to control the temperature of the satellite (not shown) through forced convection. Another advantage of the unit 10 in accordance with the present invention is that the fluid (not shown) can be used as a propellant in a propulsion system 30 to change an orbit of the satellite (not shown) at the end of its life, thus allowing eliminating the need for an external propellant to fuel the propulsion system (not shown) and as result reducing external mass added to the satellite (not shown).

1. A unit for causing angular momentum about an axis, which unit comprises, in flow sequence:
an incoming fluid pathway;
a first fluid pathway in fluid communication with the incoming fluid pathway;
a second fluid pathway in fluid communication with the incoming fluid pathway;
an outgoing fluid pathway in fluid communication with the first and second fluid pathway;
a flow regulating means for regulating the proportional flow in the first and second fluid pathways; and
wherein the first and second fluid pathways are each in the form of a loop and arranged in separate planes transverse or perpendicular to the axis and which are spaced from each other.

2.-4. (canceled)

5. A unit for causing angular momentum about an axis as claimed in claim 1 wherein the shape in which the first and second fluid pathways are arranged depends on a cross-sectional shape of a satellite to which the pathways are attached or form part of.

6.-9. (canceled)

10. A unit for causing angular momentum about an axis as claimed in claim 1 wherein the loops formed by the first and second fluid pathways share a common axis or each have their own axes, respectively.

11.-13. (canceled)

14. A unit for causing angular momentum about an axis as claimed in claim 1 wherein the fluid flow pathways are formed by passages are machined into the body, frame or chassis of an object.

15. A unit for causing angular momentum about an axis as claimed in claim 1 wherein the flow regulating means is in the form of a 1 to 2 proportional valve in fluid flow communication with the incoming fluid pathway, or two 1 to 1 proportional valves, one in the first fluid pathway and one is the second fluid pathway, and which is configured to regulate proportional flow in the first and second fluid pathways.

16. (canceled)

17. A unit for causing angular momentum about an axis as claimed in claim 1 wherein the flow regulating means is in the form of a magnetohydrodynamic pump for regulating the proportional flow of a conductive fluid, in the first and second fluid pathways.

18. (canceled)

19. A unit for causing angular momentum about an axis as claimed in claim 6 wherein the conductive fluid is a liquid metal which is selected from the group including mercury, indium, caesium, rubidium, francium, gallium and any eutectic or liquid metal alloys such as the alloy known by the trade name Galinstan.

20. A unit for causing angular momentum about an axis as claimed in claim 1 wherein the flow regulating means is in the form of magnets for regulating the flow of a conductive fluid and for inducing eddy currents in the conductive fluid or a combination of magnets and an energising means to exert a Lorenz force on the fluid.

21. A unit for causing angular momentum about an axis as claimed in claim 6 wherein the magnetohydrodynamic pump also functions as a displacement means displacing the fluid, along the fluid pathways.

22.-24. (canceled)

25. A unit for causing angular momentum about an axis of an object as claimed in claim 4, wherein the object is in the form of a satellite frame and wherein members of the satellite frame form the pathways.

26.-28. (canceled)

29. (canceled)

30.-34. (canceled)

35. A unit for causing angular momentum about an axis as claimed in claim 1, wherein the first and second fluid pathways, in the form of a helical loop, also act as a stability fluid pathway for stabilizing the object in a plane in which it is arranged.

36. A unit for causing angular momentum about an axis as claimed in claim 1 wherein first and second fluid pathways are arranged in different planes and a plane of gyroscopic stability is a combination of the different planes of the first and second fluid pathways which is dependant on the relative flow of fluid in each of the pathways.

37. A unit for causing angular momentum about an axis as claimed in claim 1, wherein an attitude detection sensor is provided for sensing the disturbance in the desired attitude of the object and a control system is arranged in communication with the sensor and flow regulating means to allow the attitude of the object to be corrected in response to the disturbance sensed by the sensor.

38.-39. (canceled)

40. A unit for causing angular momentum about an axis as claimed in claim 14, wherein the sensor is in the form of a fluid displacement rate sensor for sensing the rate of fluid displacement in the pathways which is utilized to determine a current attitude of an object to further determine if there has been a disturbance in a desired attitude of the object.

41.-42. (canceled)

43. A unit for causing angular momentum about an axis as claimed in claim 14, wherein the control system is in the form of a processor for processing a signal received from the sensor and generating an output signal in response thereto and sending the output signal to the flow regulating means to regulate the amount of flow of the fluid in the first and second pathways and wherein the fluid in the stability fluid pathway is displaced using the magnetohydrodynamic pump, the disturbance in the desired attitude of the object will result in a detectible feedback signal which is processed by the processor allowing the output signal to be generated in response thereto and sending the output signal to the flow regulating means to regulate the amount of flow of the fluid in the first and second pathways.

44.-45. (canceled)

46. A unit for causing angular momentum about an axis as claimed in claim 1 wherein a propulsion system is arranged in fluid communication therewith for allowing the fluid in the pathways to be used as a propellant by the propulsion system to propel an object.

47. A unit for causing angular momentum about an axis as claimed in claim 17 wherein the propulsion system comprises a thruster arrangement and a regulating means arrangement wherein the regulating means arrangement is in fluid flow communication with the thruster arrangement and the pathways and wherein the thruster arrangement comprises at least on thruster system and the regulating means arrangement comprises at least one valve.

48. (canceled)

49. A unit for causing angular momentum about an axis as claimed in claim 17 wherein the thruster system is in the form of a FEEP (Field Emission Electric Propulsion) thruster, a liquid metal electrospray thruster or a liquid-fed PPT (Pulsed Plasma Thruster) thruster.

50. (canceled)

51. A unit for causing angular momentum about an axis as claimed in claim 1 wherein a temperature regulating means is provided which is configured from the unit, as hereinbefore described, to control the temperature of the object by routing the fluid pathways such that fluid is displaced from a hot region of the object to a cool region of the object or vice versa to allow heat to be redistributed through the use of forced convection.

52.-59. (canceled)

60. An attitude control system of an object which comprises: —
two or more units as claimed in claim 1, wherein each unit is placed in any two or more of an X-axis, Y-axis and Z-axis of the object for allowing angular momentum to be caused about each of these axes to correct the attitude of the object in two or three dimensions.

61.-69. (canceled)
